(19) United States
(12) Patent Application Publication
(10) Pub. No.: US 2013/0140821 A1
(43) Pub. Date: Jun. 6, 2013

(54) Wave Energy Capture System

(71) Applicant: Itzhak Sapir, Irvine, CA (US)

(72) Inventor: Itzhak Sapir, Irvine, CA (US)

(73) Assignee: ISC8 Inc., Costa Mesa, CA (US)

(21) Appl. No.: 13/487,404

(22) Filed: Jun. 4, 2012

Related U.S. Application Data
(60) Provisional application No. 61/493,110, filed on Jun. 3, 2011.

(51) Int. Cl. F03B 13/16

(52) U.S. Cl. CPC F03B 13/16
USPC 290/50; 290/53

(57) ABSTRACT

A wave energy generation system. A boom element having a float element on a terminal end is reciprocatably mounted on a rotatable turret element on a watercraft. The boom element is configured to drive a linkage element which in turn drives an energy generation element. The float element rises and falls due to marine swells, the boom element reciprocates upwardly and downwardly, driving the energy generation device or element. The energy element may be an electrical generator or air compressor. One or more energy storage elements may be provided such as a battery element or air pressure storage element. The energy generator element or energy storage means or both may be used to drive a propulsion element which may be in the form of an electric motor or air motor.

### REFERENCE TO RELATED APPLICATIONS

This application is related to U.S. Provisional Patent Application No. 61/493,110 entitled “Wave Energy Capture System”, filed Jun. 3, 2011 which is incorporated herein by reference and to which priority is claimed pursuant to 35 U.S.C. 119.

### STATEMENT REGARDING FEDERALLY SPONSORED RESEARCH AND DEVELOPMENT

N/a

### BACKGROUND OF THE INVENTION

1. Field of the Invention

The invention relates generally to the field of power generation. More specifically, the invention relates to a device for generating energy from a wave source using the displacement of a watercraft on the surface of a water source having a swell or wave motion such as an ocean or lake.

2. Description of the Related Art

Several ocean energy harvesting devices and methods are known and used in marine applications. These include, but are not limited to, anchored energy-generating devices where relative motion between a rigidly-anchored component and a wave-driven flap is used to drive a generator; the use of near-shore water currents that are tunneled to ducted turbines, and devices that convert wave motion to vibration and then to electrical power that is then “harvested” by piezo-vibration devices such as is disclosed in U.S. Pub. No. 20110031749 entitled “Energy Harvesting Buoy” to Sapir et al.

These prior art energy-extracting technologies have limitations due to their need for anchoring, specific location and limited performance and efficiency in the case of vibration harvesters. The requirement for operation in open sea where marine energy may be insufficient to drive prior art devices sets a limit to the efficiency and performance level of existing energy-extraction systems. Additionally, the depth in open sea complicates the deployment of a buoy if rigid anchoring to the sea floor is required.

What is needed is a low-cost, reliable and simple wave energy capture system that overcomes the aforementioned limitations for operation in an open marine environment.

### SUMMARY OF THE INVENTION

To address the aforementioned deficiencies in the prior art, a simple and reliable wave energy generation system is provided. A boom element having a float element on a terminal end is reciprocatably mounted on a rotatable turret element on a watercraft. The boom element is configured to drive a linkage element which in turn drives an energy generation element. As the float element rises and falls due to marine swells, the boom element reciprocates upwardly and downwardly, thus mechanically driving the energy generation element.

The energy element may be an electrical generator or air compressor. One or more energy storage elements may be provided such as a battery element or air pressure storage element. The energy generator element or energy storage means or both may be used to drive a propulsion element which may be in the form of an electric motor or air motor.

The wave-powered system in the energy-harvesting device of the invention takes advantage of waves or ocean swell energy in a different manner than prior art methods described above.

In a first aspect of the invention, a wave energy capture system is disclosed comprising a watercraft element, a turret element mounted to the watercraft element, and a boom element reciprocatably mounted to the turret element and configured to travel about a predefined arc. A float element is mounted to the boom element and a linkage element provided and configured to drive an energy generation element in response to the travel.

The boom element length may be adjustable and the turret element provided to rotate about its vertical axis, i.e., about the horizontal plane. The float element may be any suitable device, element or material having suitable buoyancy characteristics as is well-known in the mechanical design arts. The linkage element may be any suitable mechanical assembly or drive configuration suitable for converting oscillating or reciprocating motion into mechanical motion suitable for driving an energy generation element such as an electrical generator or air compressor.

In a further aspect of the invention, the system comprises at least one vane element disposed on a lateral surface of the float element which disposition or angle with respect to the float element may be selectively adjustable by the user.

In a yet further aspect of the invention, the energy generation element is an electrical generator element.

In a yet further aspect of the invention, the system further comprises an electrical storage element for receiving and storing energy generated by the electrical energy generation element which may comprise a battery element or storage capacitor element or equivalent device.

In a yet further aspect of the invention, the energy generation element is an air compressor element.

In a yet further aspect of the invention, the energy storage element is a compressed air storage element configured to receive and store compressed air from an air compressor element.

In a yet further aspect of the invention, the system further comprises propulsion means coupled to and powered by the energy generation element and used to propel the watercraft on the surface of a body of water.

In a yet further aspect of the invention, the propulsion means comprises an electric motor element.

In a yet further aspect of the invention, the propulsion means is an air motor element.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE DRAWINGS

FIG. 1 shows the wave energy capture system of the invention installed on a watercraft in operational mode on the surface of a body of water.

FIG. 2A depicts a side view of the wave energy capture system of the invention in the highest position on a swell.

FIG. 2B illustrates an isometric view of the wave energy capture system of the invention in the highest position on a swell.

FIG. 3A is a side view of the wave energy capture system of the invention in the lowest position on a swell.

FIG. 3B shows an isometric view of the wave energy capture system of the invention in the lowest position on a swell.

FIGS. 4A and 413 depict the wave energy capture system of the invention with the boom in a folded configuration.

The invention and its various embodiments can be better understood by turning to the following description of the preferred embodiment which is presented as an illustrated example of the invention in any subsequent claims in any application claiming priority to this application.

It is expressly understood that the invention as defined by such claims may be broader than the illustrated embodiments described below.

### DETAILED DESCRIPTION OF THE PREFERRED EMBODIMENTS

Certain classes of prior art, lightweight unmanned watercraft utilize a hydrocarbon fuel-based system to power their internal power plants and/or a secondary electrical power supply to operate onboard devices such radar, sensor, data transmission or mission critical support devices. All of these power supply systems require manned intervention to ensure they are full or completely charged prior to the craft beginning its mission.

Once these fuels or electrical power has been consumed, the watercraft must return to some type of re-supply location to be re-fueled or recharged or both, regardless of the current status of its mission. Lightweight watercraft do not currently have an effective method of autonomously resupplying themselves with power to continue their missions for extended periods of time.

Solar and wave kinetic energy harvesting systems are being developed and used for these lightweight watercraft applications. However, these prior art systems have limited energy harvesting potential, i.e., solar energy harvesting requires an impractically large surface area for the panels. Ocean swells or waves (collectively referred to as “waves” herein) don't consistently provide a reliable source of sufficient kinetic energy but do store large amounts of energy in other forms.

The wave energy capture system of the invention system bases its wave energy harvesting potential on a different physical principle than wave kinetic energy using the physical principle of buoyancy. As set forth the below, this available form of energy is common to many ocean wave forms. By using the device of the invention and taking advantage of the physical principal of buoyancy, this energy can be harvested with high efficiency in a variety of sea or marine conditions.

As indicated above, the wave energy capture system of the invention is an ocean energy harvesting system that does not use water kinetic energy as its energy source but rather uses a different physical principle—buoyancy. There is a large amount of energy available in the rise and drop of waves even in “standing waves” that certain sea conditions generate. The wave energy capture system of the invention is designed to harvest this energy while being mounted on a vessel in open sea.

The wave energy capture system of the invention uses the peaks and valleys (or “troughs”) of marine waves and their location or phase difference relative to the watercraft to drive the system. Once the swell energy is captured, it is converted to useable energy using one of two methods to convert wave energy to a storable form of energy to be used by the watercraft's propulsion and peripheral systems.

Turning 110W to the figures wherein like references define like elements among the several views, Applicant discloses a wave energy capture system.

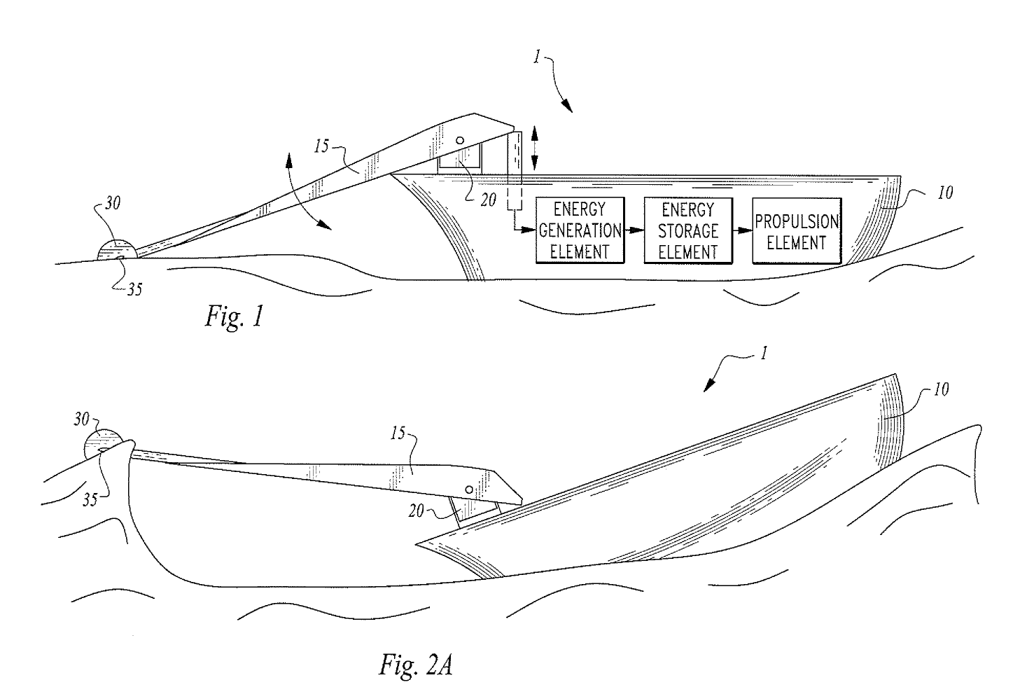

FIG. 1 shows the wave energy capture system 1 of the invention installed on a watercraft element 10 such as a boat, dingy, lightweight unmanned watercraft or equivalent vessel with its primary elements identified. A preferred embodiment of the system comprises the general elements discussed below.

An adjustable-length boom element 15 is provided and is reciprocatably mounted to a turret element 20 such as by a pivot, hinge or bearing element so as to permit its upward and downward oscillation or reciprocation with respect to watercraft element 10.

Turret element 20 is provided and preferably mounted proximal the bow of watercraft element 10 and forward of the center of the length thereof and substantially along the longitudinal axis of its length.

Boom element 15 is mounted and configured with respect to turret element 20 such that as it swings, i.e., rises and falls about a predefined arc, a mechanical linkage element 25 such as a drive rod or equivalent structure is reciprocatably driven having a predetermined stroke.

A float element 30 is provided at the opposing end of boom element 15 with fixed or adjustable angle vane elements 35 on one or more lateral surfaces of float element 35.

Mechanical linkage element 25 is connected such as by a pivot or link to an energy generation system or element to permit the reciprocation of boom element 15 along the predetermined arc portion defined by the turret-mount connection. In this manner, the boom functions as a reciprocating swing arm with respect to the watercraft body.

The principle of operation, system optimization and at least two preferred embodiments for energy conversion and storage are disclosed as follows.

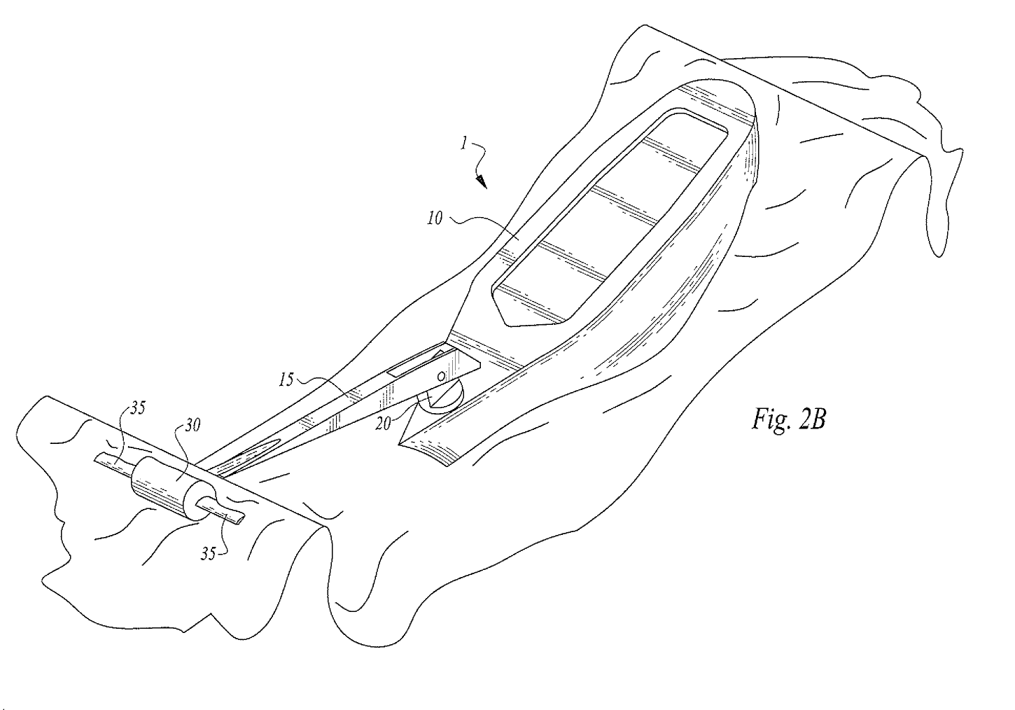

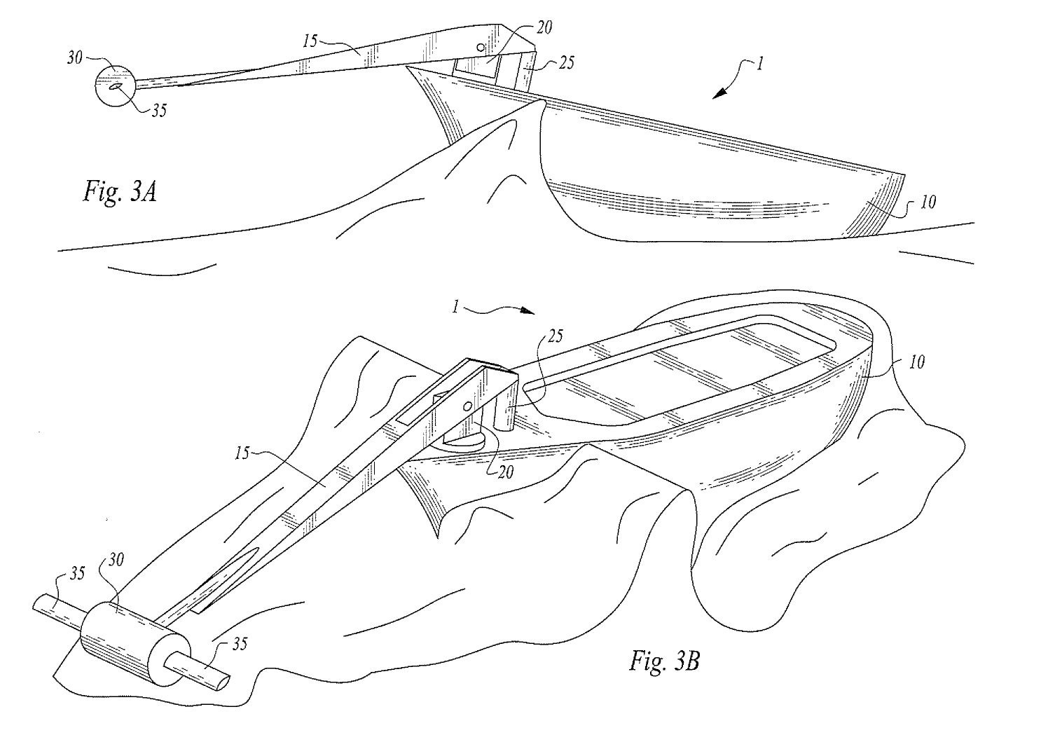

FIGS. 2A, 2B, 3A and 3B illustrate the general principles of operation of the system 12 of the invention.

When wave energy capture system 1 is in operational mode, boom element 15 is extended outward, e.g., forward of watercraft element 10 with the mass of float element 30 and boom element 15 pulling it down until it floats on the water surface. It is expressly noted the illustrated embodiment herein is merely a preferred embodiment and that the turret and boom element orientations with respect to the watercraft element may be provided at any user-defined location with respect to the watercraft element such as stern, port or leeward on the deck or hull of same.

In one mode of operation, watercraft element's 10 heading or direction of travel is substantially opposing the waves' direction or, when anchored, the bow of watercraft element 10 is oriented toward the direction of incoming waves. In such cases, a phase shift exists between the time float element 30 encounters the peak of the wave and the time the peak reaches watercraft element 10.

When a wave reaches float element 30, buoyancy forces drive float element 30 upwardly, applying a rotational, upwardly depending force on boom element 15 about the pivot point at turret element 20.

As a result, watercraft element 10 provides a reaction force and a relative movement between boom element 15 and watercraft element 10 occurs with a force that is proportional to float element's 30 buoyancy and a stroke proportional to the height of the wave.

When the peak of a wave the reaches watercraft element 10, watercraft element 10 rises and at the same time, float element 30 drops by its weight to rest on the valley of the wave or remains suspended when it reaches a predetermined arc mechanical limit as illustrated in FIGS. 3A and 3B.

The short arm of boom element 15 is connected to mechanical linkage element 25 which functions as a mechanical linkage for an energy conversion system, such as an electric generator, whereby the linkage provides the mechanic drive source for the generator.

As long as the displacement of watercraft 10 is sufficiently greater than that of float element 30, watercraft element 10 will generate sufficient reaction force to the reciprocating or oscillating rotational force of boom 15 to permit relative motion and a mechanical linkage element 25 drive force.

The force opposing the drive force of boom element 15 comes from the watercraft element's 10 inherent buoyancy characteristics.

When float element 30 rises as the result of a wave peak and boom element 15 reciprocates in the direction of power generation, the resultant rotational force effectively tries to “sink” the watercraft. As this occurs, watercraft element 10 is no longer free-floating and its submersion level increases. When submerged deeper as a result, the buoyancy forces acting on watercraft element 10 increase to create a higher equilibrium with the boom drive force.

In cases when watercraft element's 10 direction is not perpendicular to the direction of the waves, turret element 20 may be provided so as to be rotatable about the horizontal plane and be rotated to direct boom element 10 in a preferred orientation. Other optimization methods for various sea conditions are discussed below.

The net energy generated by the wave energy capture system 1 during powered travel is generally dependent on sea conditions and power consumption and, in some cases may be positive. This is not in violation with the Law of Conservation of Energy as the energy harvested by the system 1 is not that of relative lateral motion between watercraft element 10 and the sea created by watercraft element's 10 propulsion system, but rather the energy of wave height that is independent of watercraft element's 10 motion and is generated solely by the sea.

Most of the energy harvested by system 1 is generated when buoyancy forces push float element 30 upwardly. This occurs when the highest forces are generated and is the main mode of energy extraction. Nonetheless, since the boom is designed to be unbalanced (long arm and float heavier than short arm), potential energy gained by the boom in the highest position can be used to generate power as float element 30 travels downwardly to its mechanical limit. This is referred to as asymmetrical drive of the generation system or element and is discussed as part of the system 1 optimization below.

One or more fixed or adjustable vane elements 35 of system 1 may be provided and mounted on the lateral surfaces of float element 30 and serve to improve the response of directing float element 30 in the desired direction, up or down, by using only a small amount of hydrodynamic force.

During loitering or in an anchored or stationary position of watercraft element 10, any excess power over the minimum needed to power the onboard systems may be used to charge electrical energy storage devices (e.g., battery or capacitor) for later use.

A preferred embodiment of a wave energy capture system 1 of the invention may have the following specifications:

1. S (stroke)—average wave height—1 m*

2. f (frequency)—average wave frequency—0.05 Hz*( 1/20 sec—one wave every twenty seconds)

3. Float dimensions—Diameter 1.2 m×Length 2.5 m

4. Float volume—2.8 m³

5. Float net displacement (90% submerged)**—2600 Kg (seawater density—1027 Kg/m³)

6. F (force)—float net buoyancy force—25600N

*These numbers assume low-energy sea conditions.

**When buoyancy force drives float element 30 upwardly and the reacting force through boom element 15 attempts to retain it in a submerged state, system 1 is in transient mode and float element 30 is not free-floating.

The level of float element 30 submersion is dependent on the force extracted by the energy generation system that reacts to the buoyancy force. The effect of the self-weight of float element 30 in this mode is negligible and its volume is the dominant parameter. The 90% submersion level used herein is an average number.

The potential harvested energy in one stroke in these exemplar conditions is:

E=1 m×25600 N=25600 J

The potential gross power generation (100% efficiency):

P=E×f=25600 J×0.05/sec=1280 W

Assuming an 85% conversion efficiency, the net potential power generation of system 1 in a non-energetic sea condition is:

P₁=0.85×1280 W=1088W

A more energetic sea condition assumption is as follows:

S=2 m

f=0.1 Hz

For this sea condition the net potential power generation is:

E=51200 J

P=51200 J×0.1/sec=5120 W

P₂=0.85×5120 J=4352 W

As seen in FIG. 2A, the actual stroke of float 30 may be larger than the wave height when watercraft element 10 is on the front slope of a wave at the same time float element 30 is on a second wave's peak. This may happen in a certain types of sea conditions, e.g., when the wave period is relatively short.

Two optional energy generation and storage methods are disclosed.

A mechanical linkage element 25 such as drive rod is used for driving an electrical generator that may be used to charge batteries or storage capacitors. Battery power may then be used to power an electric motor for watercraft element's 10 propulsion system and supply electrical power for its peripheral systems. This type of a system is common for harvested energy and is well-characterized and fully developed. The advantages of using an electrical system are its level of maturity and the supply of both propulsion and peripheral systems' needs with a single energy system. The disadvantages are the weight and cost of batteries and the need for their periodic replacement.

Mechanical linkage element 25 of system 1 may be used to drive an air pump or compressor. In this embodiment, compressed air may be stored in a compressed air storage tank and used to power an air motor for propulsion. The same air motor may be used to drive an electrical generator to charge batteries that power watercraft element's 10 peripheral systems. The system generator and total battery capacity may be smaller than in the electrical storage embodiment since the energy storage method employed is compressed air versus a configuration where battery charging is performed on demand.

A primary advantage of a compressed air system embodiment is that storage is lower cost, light and generally maintenance-free. Although the energy density of compressed air is about 8-10 times less than for Li-ion batteries by volume and that a compressed air storage tank is about ten times larger than the equivalent volume of Li-ion batteries, a compressed air system is still much lighter (carbon fiber) and cheaper and can be stored onboard a watercraft.

Further, air motors are known marine propulsion means (early torpedoes) and unlike land vehicle applications, the ability to use sea water for thermal control (warming during operation) of air motors makes this technology well-suited for the small watercraft application. Yet further, a compressed air storage system is easy to implement in related asymmetrical drive force design as discussed above by incorporating different pressure regulators for each stroke direction in the air pump.

The following variations to the system operation may be utilized to improve or vary overall system 1 performance:

1. Rotating turret element 20 to a direction perpendicular with respect to a wave source optimized phase shift between float element 30 and watercraft element 10.

2. Adjusting vane element 35 angle to keep float element 30 substantially at 100% submersion. The control power needed to adjust the vane elements' 35 angle is negligible comparing the response and float element's 30 optimized submersion benefits. Added drag is a consideration in this embodiment.

3. Continuously adjusting the level of drive force extracted by the system 1 by using a clutch, air pressure regulators or a continuously variable transmission (CVT) gear unit to match the available energy in various sea conditions.

4. Adjusting the boom element 15 length to match the existing wave pattern and where possible, set it to position float element 30 a half-wave-length from watercraft element's 10 bow as best illustrated in FIG. 2A.

5. Using an asymmetrical drive of the generation system for harvesting the boom element 15 and float element 30 potential energy when reciprocating in opposing directions.

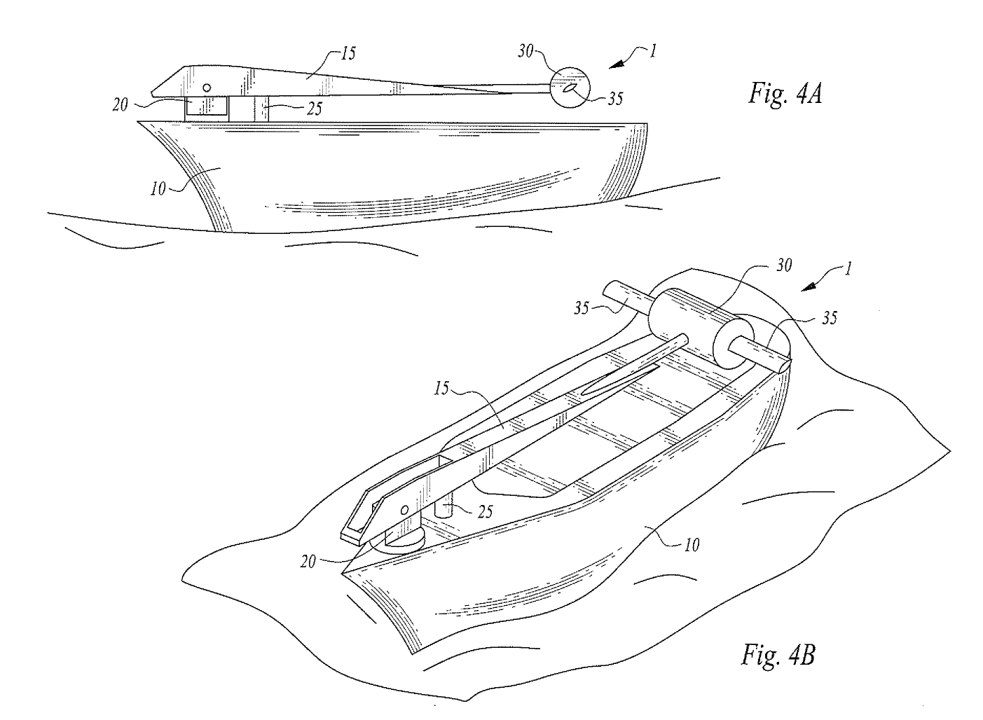

When energy storage is full and maximum travel speed is needed or when watercraft element 10 maneuvers in tight areas, the wave energy capture system 1 of the invention may be returned to a storage or non-operational configuration. FIGS. 4A and 4B depict the folded, storage configuration of invention.

Although the device of the invention is well-suited for use with unmanned watercraft, it may be used on any vessel or application including applications such as yachts as a backup energy source for prolonged sea travel. The system can be folded and unfolded as needed.

The following claims are intended not only to cover the specific embodiments disclosed, but also to cover the inventive concepts explained herein with the maximum breadth and comprehensiveness permitted by the prior art.

The words used in this specification to describe the invention and its various embodiments are to be understood not only in the sense of their commonly defined meanings, but to include by special definition in this specification, structure, material or acts beyond the scope of the commonly defined meanings. Thus, if an element can be understood in the context of this specification as including more than one meaning, then its use must be understood as being generic to all possible meanings supported by the specification and by the word itself.

The definitions of the words or elements are defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements or that a single element may be substituted for two or more elements.

Insubstantial changes from the subject matter as viewed by a person with ordinary skill in the art, now known or later devised, are expressly contemplated as being equivalent. Therefore, obvious substitutions now or later known to one with ordinary skill in the art are defined to be within the scope of the defined elements.

The inventions are thus to be understood to include what is specifically illustrated and described above, what is conceptually equivalent, what can be obviously substituted and also what essentially incorporates the fundamental idea of the invention.

Although elements may be described above as acting in certain combinations, it is to be expressly understood that one or more elements from a combination can, in some cases be excised from the combination and that the combination may be directed to a sub-combination or variation of a subcombination.

I claim:

1. A wave energy capture system comprising:
a watercraft element,
a turret element mounted to the watercraft element,
a boom element reciprocatably mounted to the turret element configured to travel about a predefined arc,
a float element mounted to the boom element, and,
a mechanical linkage element configured to drive an energy generation element in response to the travel.

2. The system of claim 1 further comprising at least one vane element disposed on a lateral surface of the float element.

3. The system of claim 1 wherein the turret element is selectively rotatable about the horizontal plane.

4. The system of claim 1 wherein the energy generation element is an electrical generator element.

5. The system of claim 4 further comprising an electrical storage element for receiving and storing energy generated by the electrical energy generation element.

6. The system of claim 5 wherein the electrical storage element is an electrical battery element.

7. The system of claim 6 wherein the electrical storage element is a capacitor element.

8. The system of claim 1 wherein the energy generation element is an air compressor element.

9. The system of claim 8 wherein the energy storage element is a compressed air storage element configured to receive and store compressed air from the air compressor element.

10. The system of claim 1 further comprising propulsion means coupled to and powered by the energy generation element.

11. The system of claim 10 wherein the propulsion means is an electric motor element.

12. The system of claim 10 wherein the propulsion means is an air motor element.
